(19) United States
(12) Patent Application Publication
(10) Pub. No.: US 2022/0186107 A1
(43) Pub. Date: Jun. 16, 2022

(54) THICKENER FOR WELLBORE ACID TREATMENT LIQUID AND WELLBORE ACID TREATMENT LIQUID USING SAME

(71) Applicants: Sanyo Chemical Industries, Ltd., Kyoto (JP); Kuraray Co., Ltd., Okayama (JP)

(72) Inventors: Sou MIYAMOTO, Kyoto (JP); Naoya HASHIMOTO, Kyoto (JP); Takuma KANESHIMA, Houston, TX (US)

(21) Appl. No.: 17/119,688

(22) Filed: Dec. 11, 2020

(51) Int. Cl. C09K 8/60; C09K 8/74

(52) U.S. Cl. CPC C09K 8/602; C09K 8/74

(57) ABSTRACT

An object of an embodiment of the present invention is to provide a thickener for a wellbore acid treatment liquid which thickener has excellent hydrolysis resistance and a high thickening capability. A thickener (X) for a wellbore acid treatment liquid contains a surfactant (a) as expressed by General Formula 1 below.

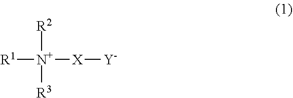

In General Formula 1, R¹ represents a C12 to C22 alkyl group or a C12 to C22 alkenyl group, R² and R³ each independently represent a C1 to C3 alkyl group or a C1 to C3 hydroxyalkyl group, X represents a C3 straight-chain hydroxyalkylene group or a C3 branched hydroxyalkylene group, and Y⁻ represents SO₃⁻.

### TECHNICAL FIELD

The present invention relates to (i) a thickener for a wellbore acid treatment liquid and (ii) a wellbore acid treatment liquid using the thickener.

### BACKGROUND ART

Acid treatment is a typical method for stimulating a wellbore for the purpose of increasing the permeability of the wellbore and improving petroleum productivity. Acid treatment is a method in which an acid treatment liquid containing e.g. (i) a strong acid such as hydrochloric acid and (ii) a thickener is injected into a wellbore and dissolves carbonate rock to create wormhole-like pathways, thereby improving permeability. In order to enable uniform subterranean distribution of the acid treatment liquid, a polymer is conventionally used as the thickener. However, an acid treatment liquid that has been thickened with a polymer presents problems such as (i) the acid treatment liquid having a higher viscosity and thus requiring time to be sent deep underground, and (ii) the need to remove the polymer remaining in the wellbore because the polymer would inhibit the recovery of petroleum.

In view of these problems, techniques involving a viscoelastic surfactant have been developed. A viscoelastic surfactant forms spherical micelles in the acid treatment liquid and has low viscosity when in the form of spherical micelles. However, when the acid dissolves carbonate underground and pH and/or salt concentration increases as a result, the viscoelastic surfactant changes from the form of spherical micelles to worm-like micelles and acts to increase the viscosity of the acid treatment liquid. One representative example of a viscoelastic surfactant that has been disclosed is fatty acid amidopropyl carboxy betaine (for example, see Patent Literature 1).

Problematically, however, when a fatty acid amidopropyl carboxy betaine in an acid treatment liquid is exposed to high temperatures for a long time, amide groups undergo hydrolysis, which prevents the fatty acid amidopropyl carboxy betaine from exhibiting a sufficient effect in high-temperature wellbores.

### CITATION LIST

### Patent Literature 1

International Publication No. WO 2007/066269

### BRIEF SUMMARY OF THE INVENTION

### Technical Problem

An embodiment of the present invention was made in view of the above problems. An object of an embodiment of the present invention lies in providing a thickener for a wellbore acid treatment liquid which thickener has excellent hydrolysis resistance and a high thickening capability.

### Solution to Problem

As a result of diligent research to solve these problems, the inventors of the present invention arrived at embodiments of the present invention. Embodiments of the present invention encompass: a thickener (X) for a wellbore acid treatment liquid, the thickener (X) containing a surfactant (a) as expressed by General Formula (1) below; and a wellbore acid treatment liquid (Y) containing the thickener and a strong acid.

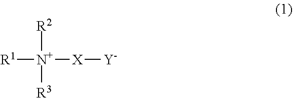

In General Formula 1, R¹ represents a C12 to C22 alkyl group or a C12 to C22 alkenyl group, R² and R³ each independently represent a C1 to C3 alkyl group or a C1 to C3 hydroxyalkyl group, X represents a C3 straight-chain hydroxyalkylene group or a C3 branched hydroxyalkylene group, and Y⁻ represents SO₃⁻.

### Advantageous Effects of Invention

The thickener for a wellbore acid treatment liquid in accordance with an embodiment of the present invention brings about the effects of having excellent hydrolysis resistance and an excellent thickening effect on an acid treatment liquid.

### DESCRIPTION OF EMBODIMENTS

A thickener (X) for a wellbore acid treatment liquid in accordance with an embodiment of the present invention (hereinafter also referred to simply as a “thickener (X)”) contains a surfactant (a) expressed by the General Formula (1) below. A wellbore acid treatment liquid (Y) (described later) in accordance with an embodiment of the present invention contains the thickener (X).

Because the thickener (X) contains the surfactant (a), the wellbore acid treatment liquid (Y) has low viscosity before dissolving carbonate but exhibits an excellent thickening effect of the acid treatment liquid once the carbonate is dissolved, even in geological formations having high temperatures. Furthermore, because the surfactant (a) has no bonds which are weak against acid, the wellbore acid treatment liquid (Y) has excellent hydrolysis resistance even when the thickener (X) is combined with a strong acid in the wellbore acid treatment liquid (Y).

The surfactant (a) in an embodiment of the present invention is expressed by the following General Formula (1).

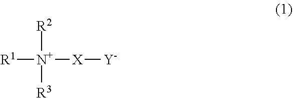

In General Formula 1, R¹ represents a C12 to C22 alkyl group or a C12 to C22 alkenyl group, R² and R³ each independently represent a C1 to C3 alkyl group or a C1 to C3 hydroxyalkyl group, X represents a C3 straight-chain hydroxyalkylene group or a C3 branched hydroxyalkylene group, and Y⁻ represents SO₃⁻.

In General Formula 1, R¹ represents a C12 to C22 alkyl group or a C12 to C22 alkenyl group. Examples of the alkyl group encompass: straight-chain alkyl groups such as a 1-dodecyl group, a 1-tridecyl group, a 1-tetradecyl group, and 1-pentadecyl group, a 1-hexadecyl group, a 1-heptadecyl group, a 1-octadecyl group, a 1-nonadecyl group, a 1-eicosyl group, and a 1-docosyl group; and branched alkyl groups such as a 2-ethyl-1-hexadecyl group, an isohexadecyl group, and an isooctadecyl group. Examples of the alkenyl group encompass alkenyl groups such as a 9-octadecene-1-yl group and a 13-docosene-1-yl group.

In terms of a thickening effect, stability in the acid treatment liquid, and handleability, R¹ is preferably a C16 to C18 alkyl group or a C16 to C18 alkenyl group.

If the number of carbon atoms in R¹ in General Formula (1) is less than 12, there will be a deterioration in the thickening capability. If the number of carbon atoms in R¹ in General Formula (i) is greater than 22, there will be decreased dissolvability in water, and thus a tendency to be difficult to produce the wellbore acid treatment liquid (Y).

In General Formula (1), R² and R³ each independently represent a C1 to C3 alkyl group or a C1 to C3 hydroxyalkyl group. Examples of the alkyl group or the hydroxyalkyl group encompass a methyl group, an ethyl group, a propyl group, a 2-hydroxyethyl group, and a 2-hydroxypropyl group.

In terms of a thickening effect, R² and R³ are preferably a C1 to C3 alkyl group, and even more preferably a methyl group.

In General Formula (1), X represents a C3 straight-chain hydroxyalkylene group or a C3 branched hydroxyalkylene group. Examples of the hydroxyalkylene group encompass a hydroxypropylene group (for example, a 1-hydroxypropylene group or a 2-hydroxypropylene group), a 1-hydroxy-1-methylethylene group, and a 1-hydroxy-2-methylethylene group.

In terms of the thickening capability and salt resistance, X is preferably a hydroxypropylene group.

The surfactant (a) expressed by General Formula (1) can be produced by e.g. a known method. For example, the surfactant (a) can be produced by a method involving: mixing, in a solvent, (i) an alkylamine or alkenylamine each having a C12 to C22 alkyl group or a C12 to C22 alkenyl group and (ii) a betainizing agent; and heating the mixture to approximately 50° C. to 80° C. to allow a betainization reaction to occur. Examples of the alkylamine or the alkenylamine encompass dodecyldimethylamine, dodecyldiethylamine, hexadecyldimethylamine, octadecenyldimethylamine, octadecyldimethylamine, hexadecyldihydroxyethylamine, octadecenyldihydroxyethylamine, octadecyldihydroxyethylamine, and docosyldimethylamine. Examples of the betainizing agent encompass sodium 3-chloro-2-hydroxypropanesulfonate.

The thickener (X) for a wellbore acid treatment liquid in accordance with an embodiment of the present invention may consist of the surfactant (a) only, or may contain other components such as water, an aqueous medium used during production of the surfactant (a), and/or a reaction byproduct. In terms of handleability and production cost, the thickener (X) preferably contains a component other than the surfactant (a), such as water.

Examples of the aqueous medium encompass an organic solvent of which 50 g or more can be dissolved in 100 g of 25° C. water. Specific examples of the aqueous medium encompass monoalcohols (such as methanol, ethanol, propanol, 3-methoxy-3-methyl-1-butanol, and isopropanol), and glycol (ethylene glycol, propylene glycol, diethylene glycol, glycerin, and tetramethylene glycol).

In terms of the thickening capability and handleability, the proportion by weight of the surfactant (a) in the thickener (X) for the wellbore acid treatment liquid is preferably 20 weight % to 70 weight %, with respect to the weight of the thickener (X).

The wellbore acid treatment liquid (Y) in accordance with an embodiment of the present invention contains (i) the thickener (X) for the wellbore acid treatment liquid in accordance with an embodiment of the present invention and (ii) a strong acid.

Examples of the strong acid encompass hydrochloric acid, hydrofluoric acid, and hydrobromic acid.

In terms of e.g. the thickening capability and cost, the strong acid is preferably hydrochloric acid.

In terms of the thickening capability and cost, the proportion by weight of the surfactant (a) in the wellbore acid treatment liquid (Y) is preferably 5 weight % to 50 weight %, even more preferably 5 weight % to 30 weight %, and particularly preferably 5 weight % to 20 weight %, with respect to the weight of the wellbore acid treatment liquid (Y).

In terms of drilling efficiency, the thickening capability, and cost, the proportion by weight of the strong acid (weight of pure acid) in the wellbore acid treatment liquid (Y) is preferably 5 weight % to 35 weight %, and even more preferably 10 weight % to 25 weight %, with respect to the weight of the wellbore acid treatment liquid (Y).

The wellbore acid treatment liquid (Y) in accordance with an embodiment of the present invention may further contain other components typically used in a wellbore acid treatment liquid, such as a diverting agent, an anti-corrosion agent, an anti-emulsion agent, a friction-reducing agent, an anti-sludge agent, a reaction-delaying agent, a fluid loss control agent, and a temporary diverting agent.

The wellbore acid treatment liquid (Y) in accordance with an embodiment of the present invention can be produced by a known method. For example, the wellbore acid treatment liquid (Y) can be produced by a method involving: introducing various components into a mixing tank having a mixer and a heating and cooling apparatus, without particular limitation to the order of introduction; and mixing the components at a temperature of 10° C. to 80° C. until uniform.

A method of using the wellbore acid treatment liquid (Y) in accordance with an embodiment of the present invention is not particularly limited. The wellbore acid treatment liquid (Y) can be used in a known wellbore acid treatment method (for example, the method disclosed in Japanese Patent Publication, Tokuko, No. Sho 63-7236) in the same manner as a typical wellbore acid treatment liquid.

The wellbore acid treatment liquid (Y) containing the thickener (X) for a wellbore acid treatment liquid in accordance with an embodiment of the present invention has a low viscosity and can therefore easily be sent deep underground. Furthermore, the wellbore acid treatment liquid (Y) dissolves carbonate when coming into contact with e.g. a limestone layer underground, and is therefore able to rapidly thicken even in conditions involving high subterranean temperatures of 50° C. to 150° C. As such, the wellbore acid treatment liquid (Y) can be suitably used for wellbore acid treatment of subterranean geological formations containing oil and gas. Specifically, the wellbore acid treatment liquid (Y) can be used in stimulating or altering the following fluids used in wellbore acid treatments: a drilling fluid, a completion fluid, a working fluid, and an acidifying fluid. Furthermore, the wellbore acid treatment liquid (Y) can be used for stimulating or altering the permeability of a subterranean geological formation during gravel packing and fracturing.

### EXAMPLES

The following description will discuss an embodiment of the present invention with reference to Examples. It should be understood that the present invention is not limited to these Examples.

Production of Thickener (X) for Wellbore Acid Treatment Liquid

### Example 1

The following were introduced into a glass reactor having a heating and stirring apparatus and a cooling apparatus: 349 parts by weight of water, 262 parts by weight of a mixed solvent in which ethanol is the main component (SOLMIX HP-1, manufactured by Japan Alcohol Trading Co., Ltd.), 201 parts by weight (1.2 molar parts) of sodium 3-chloro-2-hydroxypropanesulfonate, and 3.3 parts by weight of a 48% aqueous solution of sodium hydroxide. Next, the materials introduced into the glass reactor were heated to 60° C. in a nitrogen atmosphere, and then 182 parts by weight (1 molar part) of dodecyldimethylamine was added dropwise over 2 hours. Next, 2.6 parts by weight of a 48% aqueous solution of sodium hydroxide was added dropwise, and thereafter a reaction was allowed to take place for 25 hours at a reaction temperature of 60° C. After the solvent was removed under reduced pressure, 614 parts by weight of water was added so that a thickener (X-1) for a wellbore acid treatment liquid was obtained, the thickener (X-1) containing 30 weight % of a surfactant (a-1). The surfactant (a-1) is a compound in which, in General Formula (1), R¹ is a 1-dodecyl group, R² and R³ are each a methyl group, and X is a 2-hydroxypropylene group.

### Example 2

The following were introduced into a glass reactor having a heating and stirring apparatus and a cooling apparatus: 353 parts by weight of water, 264 parts by weight of a mixed solvent in which ethanol is the main component (SOLMIX HP-1, manufactured by Japan Alcohol Trading Co., Ltd.), 187 parts by weight (1.2 molar parts) of sodium 3-chloro-2-hydroxypropanesulfonate, and 3.0 parts by weight of a 48% aqueous solution of sodium hydroxide. Next, the materials introduced into the glass reactor were heated to 60° C. in a nitrogen atmosphere, and then 191 parts by weight (1 molar part) of tetradecyldimethylamine was added dropwise over 2 hours. Next, 2.4 parts by weight of a 48% aqueous solution of sodium hydroxide was added dropwise, and thereafter a reaction was allowed to take place for 25 hours at a reaction temperature of 60° C. After the solvent was removed under reduced pressure, 620 parts by weight of water was added so that a thickener (X-2) for a wellbore acid treatment liquid was obtained, the thickener (X-2) containing 30 weight % of a surfactant (a-2). The surfactant (a-2) is a compound in which, in General Formula (1), R¹ is a 1-tetradecyl group, R² and R³ are each a methyl group, and X is a 2-hydroxypropylene group.

### Example 3

The following were introduced into a glass reactor having a heating and stirring apparatus and a cooling apparatus: 356 parts by weight of water, 267 parts by weight of a mixed solvent in which ethanol is the main component (SOLMIX HP-1, manufactured by Japan Alcohol Trading Co., Ltd.), 172 parts by weight (1.2 molar parts) of sodium 3-chloro-2-hydroxypropanesulfonate, and 2.8 parts by weight of a 48% aqueous solution of sodium hydroxide. Next, the materials introduced into the glass reactor were heated to 60° C. in a nitrogen atmosphere, and then 199 parts by weight (1 molar part) of hexadecyldimethylamine was added dropwise over 2 hours. Next, 2.2 parts by weight of a 48% aqueous solution of sodium hydroxide was added dropwise, and thereafter a reaction was allowed to take place for 25 hours at a reaction temperature of 60° C. After the solvent was removed under reduced pressure, 866 parts by weight of water was added so that a thickener (X-3) for a wellbore acid treatment liquid was obtained, the thickener (X-3) containing 21 weight % of a surfactant (a-3). The surfactant (a-3) is a compound in which, in General Formula (1), R¹ is a 1-hexadecyl group, R² and R³ are each a methyl group, and X is a 2-hydroxypropylene group.

### Example 4

The following were introduced into a glass reactor having a heating and stirring apparatus and a cooling apparatus: 359 parts by weight of water, 269 parts by weight of a mixed solvent in which ethanol is the main component (SOLMIX HP-1, manufactured by Japan Alcohol Trading Co., Ltd.), 162 parts by weight (1.2 molar parts) of sodium 3-chloro-2-hydroxypropanesulfonate, and 2.6 parts by weight of a 48% aqueous solution of sodium hydroxide. Next, the materials introduced into the glass reactor were heated to 60° C. in a nitrogen atmosphere, and then 205 parts by weight (1 molar part) of octadecyldimethylamine was added dropwise over 2 hours. Next, 2.1 parts by weight of a 48% aqueous solution of sodium hydroxide was added dropwise, and thereafter a reaction was allowed to take place for 25 hours at a reaction temperature of 60° C. After the solvent was removed under reduced pressure, 631 parts by weight of water was added so that a thickener (X-4) for a wellbore acid treatment liquid was obtained, the thickener (X-4) containing 30 weight % of a surfactant (a-4). The surfactant (a-4) is a compound in which, in General Formula (1), R¹ is a 1-octadecyl group, R² and R³ are each a methyl group, and X is a 2-hydroxypropylene group.

### Example 5

The following were introduced into a glass reactor having a heating and stirring apparatus and a cooling apparatus: 357 parts by weight of water, 268 parts by weight of a mixed solvent in which ethanol is the main component (SOLMIX HP-1, manufactured by Japan Alcohol Trading Co., Ltd.), 167 parts by weight (1.2 molar parts) of sodium 3-chloro-2-hydroxypropanesulfonate, and 2.7 parts by weight of a 48% aqueous solution of sodium hydroxide. Next, the materials introduced into the glass reactor were heated to 60° C. in a nitrogen atmosphere, and then 203 parts by weight (1 molar part) of 9-octadecenyldimethylamine was added dropwise over 2 hours. Next, 2.1 parts by weight of a 48% aqueous solution of sodium hydroxide was added dropwise, and thereafter a reaction was allowed to take place for 40 hours at a reaction temperature of 60° C. After the solvent was removed under reduced pressure, 646 parts by weight of water was added so that a thickener (X-5) for a wellbore acid treatment liquid was obtained, the thickener (X-5) containing 23 weight % of a surfactant (a-5). The surfactant (a-5) is a compound in which, in General Formula (1), R¹ is a 9-octadecene-1-yl group, R² and R³ are each a methyl group, and X is a 2-hydroxypropylene group.

### Example 6

The following were introduced into a glass reactor having a heating and stirring apparatus and a cooling apparatus: 396 parts by weight of water, 297 parts by weight of a mixed solvent in which ethanol is the main component (SOLMIX HP-1, manufactured by Japan Alcohol Trading Co., Ltd.), 128 parts by weight (1.2 molar parts) of sodium 3-chloro-2-hydroxypropanesulfonate, and 2.1 parts by weight of a 48% aqueous solution of sodium hydroxide. Next, the materials introduced into the glass reactor were heated to 60° C. in a nitrogen atmosphere, and then 175 parts by weight (1 molar part) of 9-octadecenyldiethylamine was added dropwise over 2 hours. Next, 1.6 parts by weight of a 48% aqueous solution of sodium hydroxide was added dropwise, and thereafter a reaction was allowed to take place for 40 hours at a reaction temperature of 60° C. After the solvent was removed under reduced pressure, 695 parts by weight of water was added so that a thickener (X-6) for a wellbore acid treatment liquid was obtained, the thickener (X-6) containing 25 weight % of a surfactant (a-6). The surfactant (a-6) is a compound in which, in General Formula (1), R¹ is a 9-octadecene-1-yl group, R² and R³ are each an ethyl group, and X is a 2-hydroxypropylene group.

### Example 7

The following were introduced into a glass reactor having a heating and stirring apparatus and a cooling apparatus: 398 parts by weight of water, 299 parts by weight of a mixed solvent in which ethanol is the main component (SOLMIX HP-1, manufactured by Japan Alcohol Trading Co., Ltd.), 120 parts by weight (1.2 molar parts) of sodium 3-chloro-2-hydroxypropanesulfonate, and 2.0 parts by weight of a 48% aqueous solution of sodium hydroxide. Next, the materials introduced into the glass reactor were heated to 60° C. in a nitrogen atmosphere, and then 180 parts by weight (1 molar part) of 9-octadecenyldipropylamine was added dropwise over 2 hours. Next, 1.5 parts by weight of a 48% aqueous solution of sodium hydroxide was added dropwise, and thereafter a reaction was allowed to take place for 40 hours at a reaction temperature of 60° C. After the solvent was removed under reduced pressure, 698 parts by weight of water was added so that a thickener (X-7) for a wellbore acid treatment liquid was obtained, the thickener (X-7) containing 25 weight % of a surfactant (a-7). The surfactant (a-7) is a compound in which, in General Formula (1), R¹ is a 9-octadecene-1-yl group, R² and R³ are each a propyl group, and X is a 2-hydroxypropylene group.

### Example 8

The following were introduced into a glass reactor having a heating and stirring apparatus and a cooling apparatus: 398 parts by weight of water, 298 parts by weight of a mixed solvent in which ethanol is the main component (SOLMIX HP-1, manufactured by Japan Alcohol Trading Co., Ltd.), 121 parts by weight (1.2 molar parts) of sodium 3-chloro-2-hydroxypropanesulfonate, and 2.0 parts by weight of a 48% aqueous solution of sodium hydroxide. Next, the materials introduced into the glass reactor were heated to 60° C. in a nitrogen atmosphere, and then 179 parts by weight (1 molar part) of 9-octadecenyl-bis(2-hydroxyethyl)amine was added dropwise over 2 hours. Next, 1.5 parts by weight of a 48% aqueous solution of sodium hydroxide was added dropwise, and thereafter a reaction was allowed to take place for 40 hours at a reaction temperature of 60° C. After the solvent was removed under reduced pressure, 698 parts by weight of water was added so that a thickener (X-8) for a wellbore acid treatment liquid was obtained, the thickener (X-8) containing 25 weight % of a surfactant (a-8). The surfactant (a-8) is a compound in which, in General Formula (1), R¹ is a 9-octadecene-1-yl group, R² and R³ are each a 2-hydroxyethyl group, and X is a 2-hydroxypropylene group.

### Example 9

The following were introduced into a glass reactor having a heating and stirring apparatus and a cooling apparatus: 276 parts by weight of water, 207 parts by weight of propylene glycol, 231 parts by weight (1.2 molar parts) of sodium 3-chloro-2-hydroxypropanesulfonate, and 3.8 parts by weight of a 48% aqueous solution of sodium hydroxide. Next, the materials introduced into the glass reactor were heated to 60° C. in a nitrogen atmosphere, and then 279 parts by weight (1 molar part) of 9-octadecenyldimethylamine was added dropwise over 2 hours. Next, 2.9 parts by weight of a 48% aqueous solution of sodium hydroxide was added dropwise, and thereafter a reaction was allowed to take place for 40 hours at a reaction temperature of 60° C. In this way, a thickener (X-9) for a wellbore acid treatment liquid was obtained, the thickener (X-9) containing 30 weight % of a surfactant (a-9). The surfactant (a-9) is a compound in which, in General Formula (1), R¹ is a 9-octadecene-1-yl group, R² and R³ are each a methyl group, and X is a 2-hydroxypropylene group.

### Example 10

The following were introduced into a glass reactor having a heating and stirring apparatus and a cooling apparatus: 284 parts by weight of water, 213 parts by weight of 3-methoxy-3-methyl-1-butanol, 199 parts by weight (1.2 molar parts) of sodium 3-chloro-2-hydroxypropanesulfonate, 298 parts by weight (1 molar part) of docosyldimethylamine, and 3.2 parts by weight of a 48% aqueous solution of sodium hydroxide. Next, the materials introduced into the glass reactor were allowed to react for 2 hours at 60° C. in a nitrogen atmosphere, and then 2.5 parts by weight of a 48% aqueous solution of sodium hydroxide was added dropwise. Next, a reaction was allowed to take place for 30 hours at a reaction temperature of 60° C. In this way, a thickener (X-10) for a wellbore acid treatment liquid was obtained, the thickener (X-10) containing 30 weight % of a surfactant (a-10). The surfactant (a-10) is a compound in which, in General Formula (1), R¹ is a 1-docosyl group, R² and R³ are each a methyl group, and X is a 2-hydroxypropylene group.

### Comparative Example 1

LEBON HC-30W (manufactured by Sanyo Chemical Industries, Ltd.), which contains 29 weight % of a surfactant (a′-1), was used as a thickener (X′-1) for a wellbore acid treatment liquid. The surfactant (a′-1) is a compound in which, in General Formula (1), R¹ is a lauramidopropyl group, R² and R³ are each a methyl group, X is a methylene group, and Y⁻ is COO⁻.

### Comparative Example 2

The following were introduced into a glass reactor having a heating and stirring apparatus and a cooling apparatus: 356 parts by weight of water, 267 parts by weight of a mixed solvent in which ethanol is the main component (SOLMIX HP-1, manufactured by Japan Alcohol Trading Co., Ltd.), 122 parts by weight (1.2 molar parts) of sodium chloroacetate, and 3.4 parts by weight of a 48% aqueous solution of sodium hydroxide. Next, the materials introduced into the glass reactor were heated to 60° C. in a nitrogen atmosphere, and then 249 parts by weight (1 molar part) of 9-octadecenyldimethylamine was added dropwise over 2 hours. Next, 2.6 parts by weight of a 48% aqueous solution of sodium hydroxide was added dropwise, and thereafter a reaction was allowed to take place for 30 hours at a reaction temperature of 60° C. After the solvent was removed under reduced pressure, 626 parts by weight of water was added so that a thickener (X′-2) for a wellbore acid treatment liquid was obtained, the thickener (X′-2) containing 30 weight % of a surfactant (a′-2). The surfactant (a′-2) is a compound in which, in General Formula (1), R¹ is a 9-octadecene-1-yl group, R² and R³ are each a methyl group, X is a methylene group, and Y⁻ is COO⁻.

### Comparative Example 3

The following were introduced into a glass reactor having a heating and stirring apparatus and a cooling apparatus: 360 parts by weight of water, 270 parts by weight of a mixed solvent in which ethanol is the main component (SOLMIX HP-1, manufactured by Japan Alcohol Trading Co., Ltd.), 157 parts by weight (1.2 molar parts) of sodium 3-chloro-2-hydroxypropanesulfonate, and 2.6 parts by weight of a 48% aqueous solution of sodium hydroxide. Next, the materials introduced into the glass reactor were heated to 60° C. in a nitrogen atmosphere, and then 208 parts by weight (1 molar part) of myristamidopropyl dimethylamine was added dropwise over 2 hours. Next, 2.0 parts by weight of a 48% aqueous solution of sodium hydroxide was added dropwise, and thereafter a reaction was allowed to take place for 30 hours at a reaction temperature of 60° C. After the solvent was removed under reduced pressure, 633 parts by weight of water was added so that a thickener (X′-3) for a wellbore acid treatment liquid was obtained, the thickener (X′-3) containing 30 weight % of a surfactant (a′-3). The surfactant (a′-3) is a compound in which, in General Formula (1), R¹ is a myristamidopropyl group, R² and R³ are each a methyl group, and X is a 2-hydroxypropylene group.

### Comparative Example 4

The following were introduced into a glass reactor having a heating and stirring apparatus and a cooling apparatus: 339 parts by weight of water, 255 parts by weight of a mixed solvent in which ethanol is the main component (SOLMIX HP-1, manufactured by Japan Alcohol Trading Co., Ltd.), 240 parts by weight (1.2 molar parts) of sodium 3-chloro-2-hydroxypropanesulfonate, and 3.9 parts by weight of a 48% aqueous solution of sodium hydroxide. Next, the materials introduced into the glass reactor were heated to 60° C. in a nitrogen atmosphere, and then 160 parts by weight (1 molar part) of octyldimethylamine was added dropwise over 2 hours. Next, 3.1 parts by weight of a 48% aqueous solution of sodium hydroxide was added dropwise, and thereafter a reaction was allowed to take place for 25 hours at a reaction temperature of 60° C. After the solvent was removed under reduced pressure, 597 parts by weight of water was added so that a thickener (X′-4) for a wellbore acid treatment liquid was obtained, the thickener (X′-4) containing 30 weight % of a surfactant (a′-4). The surfactant (a′-4) is a compound in which, in General Formula (1), R¹ is a 1-octyl group, R² and R³ are each a methyl group, and X is a 2-hydroxypropylene group.

### Preparation and Evaluation of Wellbore Acid Treatment Liquid

### Examples 11 to 23 and Comparative Examples 5 to 8

Wellbore acid treatment liquids (Y-1) to (Y-13) and (Y′-1) to (Y′-4) were prepared by mixing a 35 weight % aqueous hydrochloric acid solution, water, and the thickeners (X-1) to (X-10) produced in Examples 1 to 10 and the thickeners (X′-1) to (X′-4) produced in Comparative Examples 1 to 4, in the amounts indicated in Table 1. These wellbore acid treatment liquids were evaluated as described below. The results of the evaluations are indicated in Table 1.

TABLE 1

| | | | | Examples | | | | | | | | | | |
|---|---|---|---|---|---|---|---|---|---|---|---|---|---|---|
| | | | | | 12 | 13 | 14 | 15 | 16 | 17 | 18 | 19 | 20 | 21 |
| | | | | 11 | (Y- | (Y- | (Y- | (Y- | (Y- | (Y- | (Y- | (Y- | (Y- | (Y- |
| | | | | (Y-1) | 2) | 3) | 4) | 5) | 6) | 7) | 8) | 9) | 10) | 11) |
| Preparation | Thickener | (X-1) | 30 wt % (a-1) solution | 33.3 | — | — | — | — | — | — | — | — | — | — |
| of sample | (X) for | (X-2) | 30 wt % (a-2) solution | — | 33.3 | — | — | — | — | — | — | — | — | — |
| | wellbore | (X-3) | 21 wt % (a-3) solution | — | — | 47.3 | — | — | — | — | — | — | — | — |
| | acid | (X-4) | 30 wt % (a-4) solution | — | — | — | 33.3 | — | — | — | — | — | — | 16.5 |
| | treatment | (X-5) | 23 wt % (a-5) solution | — | — | — | — | 42.7 | — | — | — | — | — | — |
| | liquid | (X-6) | 25 wt % (a-6) solution | — | — | — | — | — | 40.0 | — | — | — | — | — |
| | (g) | (X-7) | 25 wt % (a-7) solution | — | — | — | — | — | — | 40.0 | — | — | — | — |
| | | (X-8) | 25 wt % (a-8) solution | — | — | — | — | — | — | — | 40.0 | — | — | — |
| | | (X-9) | 30 wt % (a-9) solution | — | — | — | — | — | — | — | — | 10.0 | — | — |
| | | (X-10) | 30 wt % (a-10) solution | — | — | — | — | — | — | — | — | 23.3 | 33.3 | — |
| | | (X′-1) | 29 wt % (a′-1) solution | — | — | — | — | — | — | — | — | — | — | — |
| | | (X′-2) | 30 wt % (a′-2) solution | — | — | — | — | — | — | — | — | — | — | — |
| | | (X′-3) | 30 wt % (a′-3) solution | — | — | — | — | — | — | — | — | — | — | — |
| | | (X′-4) | 30 wt % (a′-4) solution | — | — | — | — | — | — | — | — | — | — | — |

| | 35 weight % aqueous HCl solution (g) | 43.0 | 43.0 | 43.0 | 43.0 | 43.0 | 43.0 | 43.0 | 43.0 | 43.0 | 43.0 | 71.5 |
|---|---|---|---|---|---|---|---|---|---|---|---|---|
| | Water (g) | 24.0 | 24.0 | 9.9 | 24.0 | 14.5 | 17.2 | 17.2 | 17.2 | 24.0 | 24.0 | 12.0 |
| Total (g) | | 100 | 100 | 100 | 100 | 100 | 100 | 100 | 100 | 100 | 100 | 100 |
| Amount of (a) in (X) (wt %) | | 30 | 30 | 21 | 30 | 23 | 25 | 25 | 25 | 30 | 30 | 30 |
| Total amount of (a) in (Y) (wt %) | | 10.0 | 10.0 | 10.0 | 10.0 | 10.0 | 10.0 | 10.0 | 10.0 | 10.0 | 10.0 | 5.0 |
| Hydrogen chloride concentration in (Y) (%) | | 15.0 | 15.0 | 15.0 | 15.0 | 15.0 | 15.0 | 15.0 | 15.0 | 15.0 | 15.0 | 25.0 |
| Calcium carbonate (g) | | 20.7 | 20.7 | 20.7 | 20.7 | 20.7 | 20.7 | 20.7 | 20.7 | 20.7 | 20.7 | 34.3 |
| Evaluation | (1) | G | G | G | G | G | G | G | G | G | G | G |
| | (2) | G | G | G | G | G | G | G | G | G | G | G |
| | (3) | G | G | VG | VG | VG | VG | VG | VG | E | VG | G |
| | (4) | G | G | VG | VG | VG | VG | VG | VG | VG | G | G |

| | | | | Examples | | Comparative Examples | | | |
|---|---|---|---|---|---|---|---|---|---|
| | | | | 22 | 23 | 5 | 6 | 7 | 8 |
| | | | | (Y-12) | (Y-13) | (Y′-1) | (Y′-2) | (Y′-3) | (Y′-4) |
| Preparation | Thickener | (X-1) | 30 wt % (a-1) solution | — | — | — | — | — | — |
| of sample | (X) for | (X-2) | 30 wt % (a-2) solution | — | — | — | — | — | — |
| | wellbore | (X-3) | 21 wt % (a-3) solution | — | — | — | — | — | — |
| | acid | (X-4) | 30 wt % (a-4) solution | 50 | 66.5 | — | — | — | — |
| | treatment | (X-5) | 23 wt % (a-5) solution | — | — | — | — | — | — |
| | liquid | (X-6) | 25 wt % (a-6) solution | — | — | — | — | — | — |
| | (g) | (X-7) | 25 wt % (a-7) solution | — | — | — | — | — | — |
| | | (X-8) | 25 wt % (a-8) solution | — | — | — | — | — | — |
| | | (X-9) | 30 wt % (a-9) solution | — | — | — | — | — | — |
| | | (X-10) | 30 wt % (a-10) solution | — | — | — | — | — | — |
| | | (X′-1) | 29 wt % (a′-1) solution | — | — | 34.4 | — | — | — |
| | | (X′-2) | 30 wt % (a′-2) solution | — | — | — | 33.3 | — | — |
| | | (X′-3) | 30 wt % (a′-3) solution | — | — | — | — | 33.3 | — |
| | | (X′-4) | 30 wt % (a′-4) solution | — | — | — | — | — | 33.3 |

| | 35 weight % aqueous HCl solution (g) | 48.5 | 28.5 | 43.0 | 43.0 | 43.0 | 43.0 |
|---|---|---|---|---|---|---|---|
| | Water (g) | 1.5 | 5.0 | 22.7 | 24.0 | 24.0 | 24.0 |
| Total (g) | | 100 | 100 | 100 | 100 | 100 | 100 |
| Amount of (a) in (X) (wt %) | | 30 | 30 | 29 | 30 | 30 | 30 |
| Total amount of (a) in (Y) (wt %) | | 15.0 | 20.0 | 10.0 | 10.0 | 10.0 | 10.0 |
| Hydrogen chloride concentration in (Y) (%) | | 17.0 | 10.0 | 15.0 | 15.0 | 15.0 | 15.0 |
| Calcium carbonate (g) | | 23.3 | 13.7 | 20.7 | 20.7 | 20.7 | 20.7 |
| Evaluation | (1) | G | G | G | P | G | G |
| | (2) | G | G | P | N/A | P | G |
| | (3) | VG | VG | P | | P | P |
| | (4) | VG | VG | N/A | | N/A | P |

Notes for Table 1:
“Weight %” is abbreviated to “wt %”.
Evaluation (1): Viscosity of wellbore acid treatment liquid (Y) at 80° C.
Evaluation (2): Appearance after heating wellbore acid treatment liquid (Y) at 90° C. for 10 hours
Evaluation (3): Viscosity of (Y) at 80° C. when calcium carbonate was added immediately after preparation of (Y)
Evaluation (4): Viscosity of (Y) at 80° C0 after heating at 90° C . for 10 hours and subsequent addition of calcium carbonate
N/A: Could not be evaluated

(1) Viscosity Evaluation Immediately after Preparation: Viscosity of Wellbore Acid Treatment Liquid (Y) at 80° C.

For each of the wellbore acid treatment liquids (Y-1) to (Y-13) and (Y′-1) to (Y′-4), after the wellbore acid treatment liquid was prepared, the temperature of the wellbore acid treatment liquid was adjusted by placing the wellbore acid treatment liquid in a hot bath at 80° C. for 30 minutes. Viscosity at 80° C. was then evaluated. The viscosity was measured using a B-type viscometer (TVB-10M, manufactured by Told Sangyo Co., Ltd.). The measurements were evaluated using the criteria below. Note that (Y′-2) solidified and therefore was not subjected to the evaluations detailed in items (2) to (4) below.

Viscosity of not more than 200 mPa·s: Good (G)

Viscosity of greater than 200 mPa·s, or samples that solidified: Poor (P)

(2) Hydrolysis Resistance Evaluation: Appearance after Heating Wellbore Acid Treatment Liquid (Y) at 90° C. for 10 Hours

For each of the wellbore acid treatment liquids (Y-1) to (Y-13) and (Y′-1) to (Y′-4), the wellbore acid treatment liquid was heated in a hot bath at 90° C. for 10 hours. The sample thus heated was evaluated, based on its appearance, for the occurrence of change over time. The following criteria were used for this evaluation.

No separation occurred in wellbore acid treatment liquid: Good (G)

Separation occurred in wellbore acid treatment liquid: Poor (P)

(3) Thickening Capability Evaluation: Viscosity of the Wellbore Acid Treatment Liquid (Y) at 80° C. when Calcium Carbonate is Added Immediately after Preparation

For each of the wellbore acid treatment liquids (Y-1) to (Y-13) and (Y′-1) to (Y′-4) immediately after preparation, 100 parts by weight of the wellbore acid treatment liquid was subject to temperature adjustment at 80° C. for 30 minutes. Thereafter, calcium carbonate was added thereto in the amount indicated in Table 1 (13.7 parts by weight, 20.7 parts by weight, 23.3 parts by weight, or 34.3 parts by weight), and mixing was performed for 10 minutes. After mixing, the viscosity of the wellbore acid treatment liquid at 80° C. was measured. The viscosity was measured using a B-type viscometer (TVB-10M, manufactured by Toki Sangyo Co., Ltd.). The measurements were evaluated using the criteria below.

Viscosity of not less than 100 Pa·s: Excellent (E)

Viscosity of not less than 1 Pa·s but less than 100 Pa·s:

### Very Good (VG)

Viscosity of not less than 0.3 Pa·s but less than 1 Pa·s: Good (G)

Viscosity of less than 0.3 Pa·s: Poor (P)

(4) Thickening Capability Evaluation: Viscosity of Wellbore Acid Treatment Liquid (Y) at 80° C., after Heating at 90° C. for 10 Hours and Subsequent Addition of Calcium Carbonate

For each of the wellbore acid treatment liquids (Y-1) to (Y-13) and (Y′-1) to (Y′-4), 100 parts by weight of the wellbore acid treatment liquid was heated at 90° C. for 10 hours as in item (2) above. Thereafter, calcium carbonate was added thereto in the amount indicated in Table 1 (13.7 parts by weight, 20.7 parts by weight, 23.3 parts by weight, or 34.3 parts by weight), and mixing was performed for 10 minutes at 80° C. After mixing, the viscosity of the wellbore acid treatment liquid at 80° C. was measured. The viscosity was measured using a B-type viscometer (TVB-10M, manufactured by Toki Sangyo Co., Ltd.). The measurements were evaluated using the criteria below. Note that because (Y′-1) and (Y′-3) exhibited separation during the evaluation detailed in item (2) above, they were unsuitable for evaluation in this thickening capability test and thus were not evaluated.

Viscosity of not less than 100 Pa·s: Excellent (E)

Viscosity of not less than 1 Pa·s but less than 100 Pa·s: Very Good (VG)

Viscosity of not less than 0.3 Pa·s but less than 1 Pa·s: Good (G)

Viscosity of less than 0.3 Pa·s: Poor (P)

As indicated in Table 1, the wellbore acid treatment liquids of Examples 11 to 23, which used the thickeners (X-1) to (X-10) in accordance with an embodiment of the present invention, had excellent hydrolysis resistance and an excellent thickening capability as compared to the wellbore acid treatment liquids of Comparative Examples 5 to 8, which used the comparative thickeners (X′-1) to (X′-4). In particular, the wellbore acid treatment liquids of Examples 13 to 18 and Examples 21 to 23 showed little difference in viscosity whether immediately after being prepared or after being heated at 90° C. for 10 hours, and had very favorable hydrolysis resistance. Thus, it was found that these wellbore acid treatment liquids made it possible to achieve a stable thickening effect.

### INDUSTRIAL APPLICABILITY

The thickener for a wellbore acid treatment liquid in accordance with an embodiment of the present invention can be suitably used in a wellbore acid treatment carried out during production of e.g. petroleum or gas.

1. A thickener (X) for a wellbore acid treatment liquid, comprising:
a surfactant (a) as expressed by the following General Formula (1), 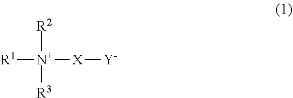
where R¹ represents a C16 to C22 alkyl group or a C16 to C22 alkenyl group, R² and R³ each independently represent a C1 to C3 alkyl group or a C1 to C3 hydroxyalkyl group, X represents a C3 straight-chain hydroxyalkylene group or a C3 branched hydroxyalkylene group, and Y⁻ represents SO₃⁻; and
a component selected from the group consisting of water, an aqueous medium used in the production of the surfactant (a), a by-product of a reaction used in the production of the surfactant (a), and a combination of two or more of the aforementioned;
wherein a proportion by weight of the surfactant (a) is in a range of 20 weight % to 70 weight % with respect to a weight of the thickener (X) containing a combination of the thickener and the component.

2. The thickener (X) according to claim 1, wherein the surfactant (a) is such that, in General Formula (1), R¹ is a C16 to C18 alkyl group or a C16 to C18 alkenyl group.

3. A wellbore acid treatment liquid (Y) comprising:
the thickener (X) according to claim 1; and
an acid;
wherein the acid is selected from the group consisting of hydrochloric acid, hydrofluoric acid and hydrobromic acid.

4. The wellbore acid treatment liquid (Y) according to claim 3, wherein a proportion by weight of the acid in the wellbore acid treatment liquid (Y) is in a range of 5 weight % to 35 weight % with respect to the weight of the wellbore acid treatment liquid (Y).

5. The wellbore acid treatment liquid (Y) according to claim 3, wherein a proportion by weight of the surfactant (a) in the wellbore treatment liquid (Y) is in a range of 5 weight % to 50 weight % with respect to the weight of the wellbore acid treatment liquid (Y).

6. The wellbore treatment liquid (Y) according to claim 3, wherein the acid is hydrochloric acid.

7. The thickener (X) according to claim 1, wherein R¹ represents a C16-C18 alkyl group.

8. The thickener (X) according to claim 1, wherein R¹ represents a C16-C18 alkenyl Group.

9. The thickener (X) according to claim 1, wherein the aqueous medium comprises an organic solvent.

10. The thickener (X) according to claim 9, wherein the aqueous medium comprises the organic solvent of which at least 50 g can be dissolved in 100 g of 25° C. water.

11. The thickener (X) according to claim 1, wherein the component is water.

12. The thickener (X) according to claim 1, wherein R² and R³ are each the C1 to C3 alkyl group.

13. The thickener (X) according to claim 12, wherein R² and R³ are each a methyl group.

14. The thickener (X) according to claim 1, wherein X is a 2-hydroxypropylene group.

15. The thickener (X) according to claim 1, wherein R² and R³ each independently represent the C1 to C3 alkyl group or the C1 to C3 hydroxyalkyl group selected from the group consisting of a methyl group, an ethyl group, a propyl group, a 2-hydroxyethyl group, and a 2-hydroxypropyl group.

16. The thickener (X) according to claim 1, wherein X represents the C3 straight-chain hydroxyalkylene group or the C3 branched hydroxyalkylene group selected from the group consisting of a 1-hydroxypropylene group, a 2-hydroxypropylene group, a 1-hydroxy-1-methylethylene group, and a 1-hydroxy-2-methylethylene group.

17. The well-bore treatment liquid (Y) according to claim 3 further comprising a diverting agent, an anti-corrosion agent, an anti-emulsion agent, a friction-reducing agent, an anti-sludge agent, a reaction-delaying agent, a fluid loss control agent, a temporary diverting agent and a combination of two or more of the aforementioned.

18. The thickener (X) according to claim 1, wherein the aqueous medium is selected from the group consisting of methanol, ethanol, propanol, 3-methoxy-3-methyl-1-butanol, isopropanol, ethylene glycol, propylene glycol, diethylene glycol, glycerin, and tetramethylene glycol.

19. The thickener (X) according to claim 1, wherein the surfactant (a) is such that, in General Formula (1), R¹ is a C16 to C18 alkyl group or a C16 to C18 alkenyl group, R² and R³ are each a methyl group, and X is a 2-hydroxypropylene group.
